(19) United States
(12) Patent Application Publication
(10) Pub. No.: US 2024/0393475 A1
(43) Pub. Date: Nov. 28, 2024

(54) SYSTEMS AND METHODS FOR GLOBAL POSITIONING NAVIGATION THROUGH MULTIPLEXING OF SIGNALS FROM MULTIPLE ANTENNAS OF A SINGLE RECEIVER

(71) Applicant: Robotic Research OpCo, LLC, Clarksburg, MD (US)

(72) Inventors: Alberto Daniel Lacaze, Potomac, MD (US); Karl Nicholas Murphy, Cocoa Beach, FL (US)

(21) Appl. No.: 18/202,757

(22) Filed: May 26, 2023

(51) Int. Cl. G01S 19/35; G01S 19/18

(52) U.S. Cl. CPC G01S 19/35; G01S 19/18

(57) ABSTRACT

A navigation system comprises at least one processor, a receiver in communication with the at least one processor and a non-transitory computer-readable medium storing instructions that when executed by the at least one processor results in receiving, by at least two antennas coupled to a receiver, a plurality of signals from a plurality of different remote transmitters, transmitting, from a first antenna and for a first time instance, a first input signal to the receiver, the first input signal associated with a first group of the plurality of signals, transmitting, from a second antenna and for a second time instance subsequent to the first time instant, a second input signal to the receiver, the second input signal associated with a second group of the plurality of signals and determining, based partly on the first and second input signals, an indication associated with bearing or location of a craft.

### FIELD

The present application relates generally to systems and methods for navigation via Global Navigation Satellite System (GNSS) and/or Global Positioning System (GPS) navigation, and, more particularly, relates to systems and methods for selective and/or sequential use of multiple antennas coupled to a GPS receiver for determining position and/or directional heading of a craft or vehicle.

### BACKGROUND

A conventional Global Navigation Satellite System (GNNS) and/or Global Positioning System (GPS) requires at least one receiver with an incorporated antenna to receive signals from multiple satellites to determine geolocation of an object. Although commercially available receivers are generally effective for this intended purpose, the receivers have some deficiencies which detract from their overall usefulness. The antennas associated with the receiver are fixed and omnidirectional, and may not have a clear line of sight to a satellite transmitter particularly when moving through urban or forested settings where buildings and vegetation often interfere with signals transmitted from the satellite transmitters. The use of multiple satellite receivers on a craft is infeasible and cost prohibitive. M-code receivers used in military applications are extremely expensive due in part to their antijamming and signal encryption capabilities. Moreover, available space on a military craft is restricted especially for an antenna to be mounted on the top of a military vehicle.

### SUMMARY

Accordingly, the present invention is directed to a system and methodology for use in a GPS or GNNS environment for determining the position and/or heading of a craft, for example, when positioned within obstacles of a terrain and while traversing the terrain. In illustrative embodiments, multiple satellite antennas are mounted and dispersed at different locations on the craft. For example, the antennas may be mounted at the sides and/or fore and aft locations of the craft. A receiver is coupled to the multiple antennas. The receiver includes multiplexer logic to selectively switch between satellite antennas on the craft to sequentially receive transmitted signals from one or more satellites in communication with the respective antennas. The signals are processed by the receiver to determine, based at least in part on the satellite signal data, the position and/or heading of the craft. In some embodiments, the signal data is combined with positional data obtained by sensors on the craft to determine position and/or bearing of the craft.

In one illustrative embodiment, a navigation system comprises at least one processor, a receiver in communication with the at least one processor and a non-transitory computer-readable medium storing instructions that when executed by the at least one processor results in:
receiving, by at least two antennas coupled to a receiver, a plurality of signals from a plurality of different remote transmitters;
transmitting, from a first antenna and for a first time instance, a first input signal to the receiver, the first input signal associated with a first group of the plurality of signals;
transmitting, from a second antenna and for a second time instance subsequent to the first time instant, a second input signal to the receiver, the second input signal associated with a second group of the plurality of signals; and
determining, based at least in part on the first and second input signals, an indication associated with at least one of a bearing and a location of a craft.

In some embodiments, the instructions, when executed by the at least one processor, further causes multiplexer logic to selectively deliver an individual one of the first and second input signals to the receiver. In some embodiments, the instructions, when executed by the at least one processor, causes the multiplexer logic to selectively deliver the individual one of the first and second input signals based at least in part on time criteria. In some embodiments, the instructions, when executed by the at least one processor, causes the multiplexer logic to selectively deliver the individual one of the first and second input signals based at least in part on one or more parameters associated with the first and second groups of the plurality of signals. The one or more parameters may include at least one of signal strength, signal quality or noise or, alternatively, based on a number of signals received by the first antenna and the second antenna.

In some embodiments, the instructions, when executed by the at least one processor, further causes the multiplexer logic to:
selectively transmit from the first antenna and for a third time instance subsequent to the second time instance, a third input signal to the receiver, the third input signals associated with a third group of the plurality of signals; and
selectively transmit from the second antenna and for a fourth time instance subsequent to the third time instance, fourth input signals to the receiver, the fourth input signals associated with a fourth group of the plurality of signals;
The first and second antennas are mounted to the craft, and, in some embodiments, in spaced relation.

At least one of the first and second antennas may be a directional antenna. In some embodiments, an actuator is operable to receive a command from the at least one processor and in response to the command, reorient the directional antenna from an initial bearing to a second bearing.

In some embodiments, the instructions, when executed by the at least one processor, further causes one or more sensors associated with the craft to collect positional data; and
wherein determining an indication includes utilizing the positional data to determine the at least one of a bearing and a location of a craft.

In some illustrative embodiments, a method for determining at least one of a location and bearing of a craft, comprises:
mounting first and second antennas and a receiver coupled to the first and second antennas to a craft;
receiving, by the first and second antennas, a plurality of signals from a plurality of different remote transmitters;
sequentially transmitting to the receiver input signals from the first antenna and from the second antenna; and
determining based at least in part on the input signals transmitted from each of the first and second antennas at least one of a bearing and a location of the craft;
wherein the steps are performed by at least one processor coupled to memory.

In some embodiments, sequentially transmitting includes:
transmitting, from the first antenna and for a first time instance, a first input signal to the receiver, the first input signal associated with a first group of the plurality of signals; and
transmitting, from the second antenna and for a second time instance subsequent to the first time instant, a second input signal to the receiver, the second input signal associated with a second group of the plurality of signals.

In some embodiments, sequentially transmitting is performed with a multiplexer coupled to the receiver. In some embodiments, sequentially transmitting includes switching, via the multiplexer, transmission of the first input signal of the first antenna to the second input signal of the second transmitter after a predetermined time period.

In some embodiments, sequentially transmitting includes switching, via the multiplexer, transmission of the first input signal of the first antenna to the second input signal of the second transmitter based at least in part on one or more parameters associated with the plurality of signals. In some embodiments, the one or more parameters include at least one of signal strength, signal quality, or, alternatively, based on a number of signals received by the first antenna and the second antenna.

In some embodiments, the method includes collecting positional data with one or more sensors associated the craft; and
wherein determining an indication includes utilizing the positional data to determine the at least one of a bearing and a location of the craft.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a diagram of a system and methodology of a Navigation System incorporating the receiver and multiplexer architecture in accordance with one or more illustrative embodiments;

FIG. 2 is a diagram illustrating the receiver, multiplexer and antenna architecture of the Navigation System in accordance with one or more illustrative embodiments;

FIG. 3 is a diagram of a system and methodology of a Navigation System incorporating the receiver and multiplexer architecture in accordance with one or more illustrative embodiments;

FIG. 4 is a block diagram of the Navigation System in accordance with one or more illustrative embodiments;

FIG. 5 is a block diagram of the Navigation System in accordance with one or more illustrative embodiments;

FIG. 6 is a block diagram of the Navigation System in accordance with one or more illustrative embodiments;

FIG. 7 is a flow chart of a methodology of use of the Navigation System in accordance with one or more illustrative embodiments;

FIG. 8 is a diagram of a system and methodology of a Navigation System incorporating the receiver and multiplexer architecture in accordance with one or more illustrative embodiments; and

FIG. 9 is a flow chart illustrating one or more algorithms embodied within the Navigation System application in accordance with one or more illustrative embodiments.

### DETAILED DESCRIPTION

In the following description of exemplary embodiments, reference is made to the accompanying drawings (where like numbers represent like elements), which form a part hereof, and in which is shown by way of illustration exemplary embodiments in which the invention may be practiced. These embodiments are described in sufficient detail to enable those skilled in the art to practice the invention, but some embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

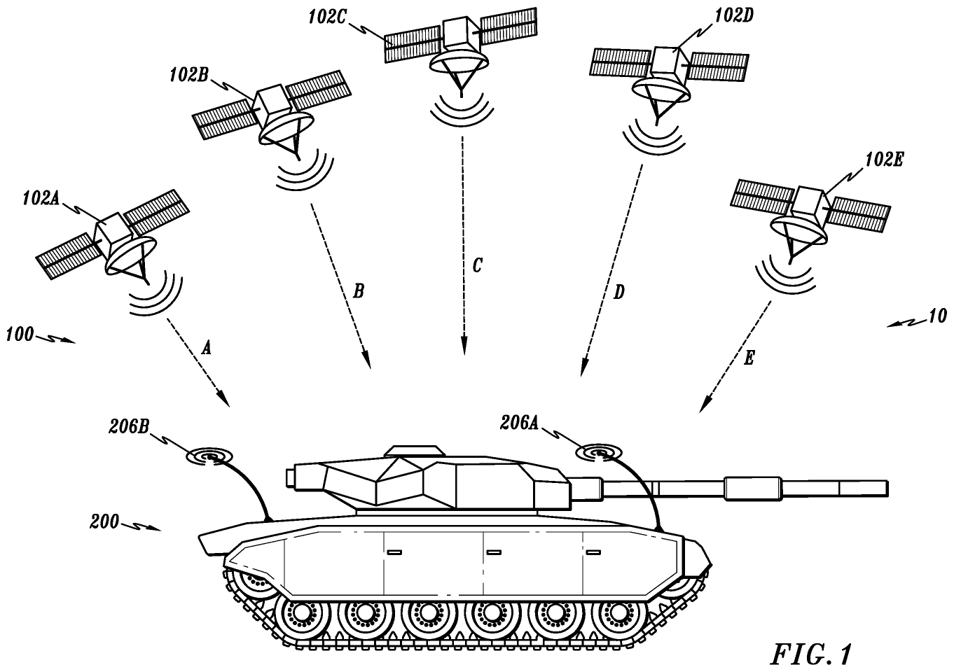

Referring initially to FIG. 1, a view of the system and methodology in accordance with one illustrative embodiment of the present disclosure is depicted. The system 10 may include a Global Navigation Satellite System (GNSS) and/or Global Positioning System (GPS) (hereinafter referred to as “PS” for Positioning System) 100 and a craft or vehicle, for example, a military armored vehicle, represented generally as reference numeral 200. The PS 100 may be well-known and in common commercial usage around the world for personal, commercial, and military location-finding and navigation and may comprise one or more specific satellite constellation systems such as a GPS, BeiDou Navigation Satellite System (BDS), the Galileo system, the GLObalnaya NAvigazionnaya Sputnikovaya Sistema (GLONASS), the Indian Regional Navigation Satellite System (IRNSS)/Navigation Indian Constellation (NavIC), and/or the Quasi-Zenith Satellite System (QZSS). The constellation satellite architecture includes multiple satellites 102A-102E which distribute signals A-E respectively.

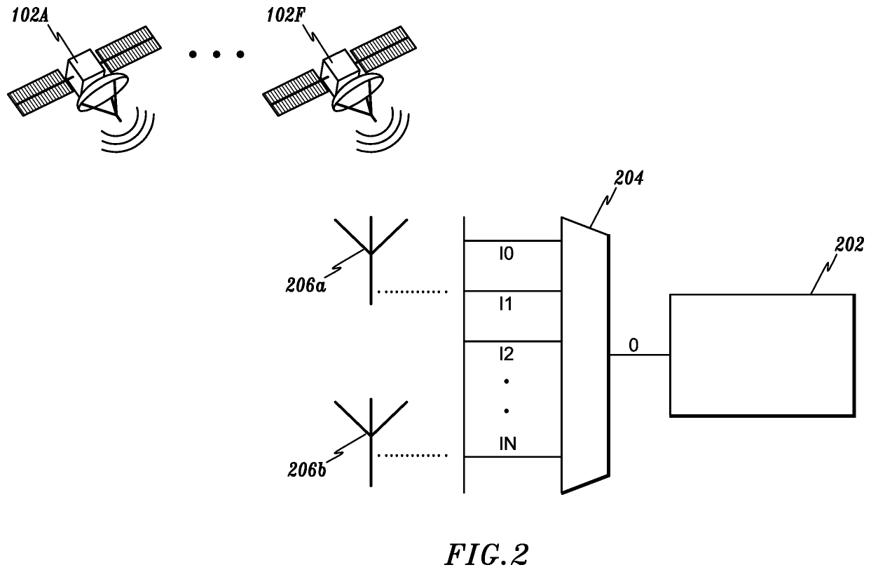

With reference to FIG. 2, in conjunction with FIG. 1, the craft 200 may be any commercial or military vehicle adapted for marine, land and air use including, without limitation, a car, truck, military tank or armored vehicle, a commercial or military plane, a commercial or military ship etc. In illustrative embodiments, the craft 200 includes a receiver, for example, a single GNNS or GPS receiver 202 (and associated processor(s) with memory and logic) mounted, or incorporated within, the craft 200. In military applications, the receiver 202 is an M-code receiver. An M-code receiver is designed to increase security of satellite signals and improve anti-jamming capabilities. An M-code receiver utilizes secure encryption technologies, namely, the Modernized Navstar Security Algorithm (MNSA), making the receiver 202 more resilient against spoofing. In some embodiments, the receiver 202 may be any commercially available GPS receiver. In some embodiments, two receivers may be provided including an M-code receiver and a commercially available receiver.

The receiver 202 incorporates, is coupled to, or otherwise associated with, a multiplexer 204. The multiplexer 204 receives data or signals representative of the signals A-E emitted by the satellites 202A-202E as input and multiplexes the signals into a single output channel for further processing. The multiplexer 204 may be a code division multiple (CDMA) multiplexer, a time division multiplexer (TDM), a space division multiplexer (SDM) or a frequency division multiplexer (FDM). In illustrative embodiments, the multiplexer 204 enables rapid sequencing of the signals of two or more satellites through a tracking channel. This ensures navigation signals from the satellites tracked by the channel are essentially acquired in close proximity or essentially simultaneously. The function of the multiplexer 204 will be described in greater detail hereinbelow.

With continued reference to FIGS. 1 and 2, a plurality of signal receiving antennas 206a, 206b are mounted to the craft 200. In illustrative embodiments, two antennas 206a, 206b are used; however, more than two antennas 206a, 206b are contemplated. The antennas 206a, 206b are associated or otherwise coupled to the receiver 202 and to the multiplexer 204, and receive the raw satellite signals A-E from the satellites 202A-202F for transmitting as input I₀, I₁, I₂ . . . . I_{N}. The antennas 206a, 206b may be mounted to any surface of the craft 200 in spaced relation. For example, the antennas 206a, 206b may be mounted to the fore or aft areas of the craft 200, the sides of the craft 200, the deck or top of the craft 200 etc. In illustrative embodiments, the antennas 206a, 206b are mounted to any convenient location or available space on the craft 200, and are not required to be mounted to a top surface of the craft 200. In some embodiments, the antennas 206a, 206b may be spaced on the craft 200 as far as possible. In some embodiments, each antenna 206a, 206b is capable of receiving all signals A-E from the satellites 202A-202E. In some embodiments, the antennas 206a, 206b are assigned to specific satellites 202A-202E. FIG. 1 illustrates the antennas 206a, 206b mounted to the fore and aft areas of the craft 200.

With continued reference to FIG. 2, the multiplexer 204 receives the inputs signals I₀, I₁, I₂ . . . I_{N} from the two antennas 206a, 206b. The input signals I₀, I₁, I₂ . . . . I_{N} are derived from the raw satellite signals A-E received from the satellites 202A-20E. Based on one or more parameters associated with the signals I₀, I₁, I₂ . . . . I_{N} or on other non-related parameters, the multiplexer 204 switches between the antennas 206a, 206b and the respective signals I₀, I₁, I₂ . . . . I_{N} to generate an output O which is processed to assist in determining the location and/or bearing of the craft 200. In illustrative embodiments, once initiated, the multiplexing or switching occurs within milliseconds.

In some embodiments, the multiplexer 204 may switch between antennas 206a, 206b and input signals I₀, I₁, I₂ . . . . I_{N} based on time parameters. For example the multiplexer 204 may switch after a predetermined time period or instance is realized for each antenna 206a, 206b and signals I₀, I₁, I₂ . . . . I_{N}, i.e., the multiplexer 204 channels a first signal, for example, signal I₀ from the first antenna 206a as output O for a first predetermined time and then switches to channeling a second signal for example, signal I₁ from the second antenna 206b as output O for a second period of time. After the second predetermined time, the multiplexer 204 may switch again and transmit additional signals from the first antenna 206a as output O to the receiver 202 for a third predetermined time and optionally switch back to the second antenna 206b and transmit additional signals from the second antenna 206b as output O to the receiver 202 for a fourth predetermined time. The first and second predetermined times or time instances may be the same or different. In illustrative embodiments, the first and second times may be milliseconds or greater. Similarly, the third and fourth predetermined time periods may be the same or different.

In illustrative embodiments, the multiplexer 204 may switch between respective signals I₀, I₁, I₂ . . . . I_{N} of the respective antennas 206a, 206b based on signal strength, signal quality, noise and/or complete loss of signal as determined based on logic associated with the receiver 202 and/or multiplexer 204. In some embodiments, the multiplexer 204 may switch based on the number of signals received by the antennas 206a, 206b. In some embodiments, the determination is made to select or switch a respective antenna 206a, 206b based on the number of satellite fixes, for example, the number of satellites in communication with the respective antenna 206a, 206b. For example, and without limitation, if it is determined that antenna 206a is in communication with more satellites than antenna 206b, antenna 206a is selected.

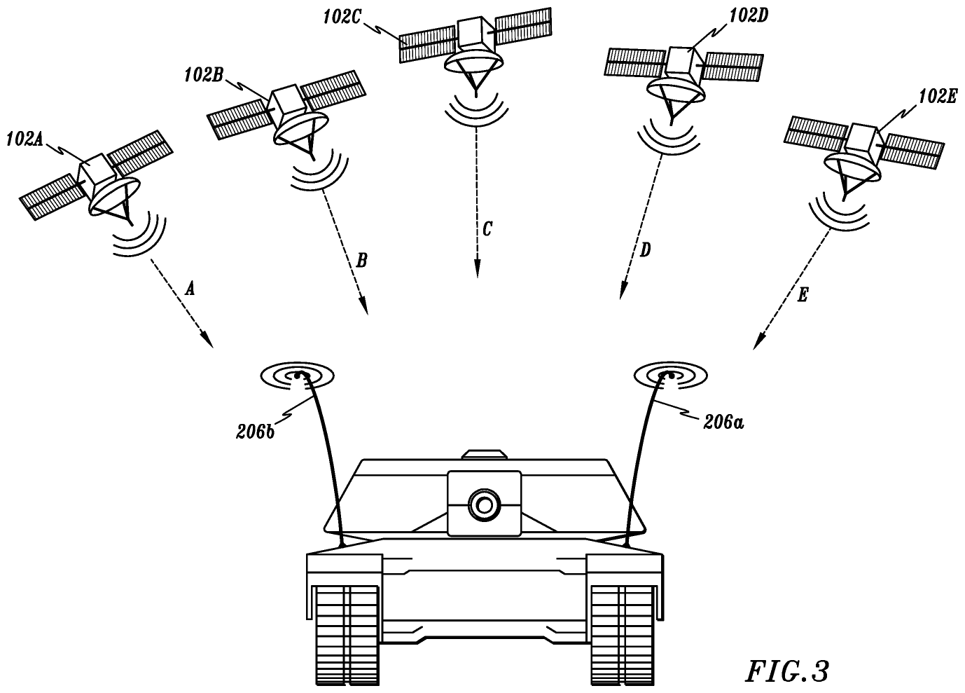

FIG. 3 illustrates the antennas 206a, 206b mounted to the lateral sides of the craft 200. While the antennas 206a, 206b are depicted for ease of illustration as long/whip-style antennas, in some embodiments either or both of the antennas 206a, 206b may comprise short mast extensions that, e.g., are not in line-of-sight with each other. According to some embodiments, the antennas 206a, 206b may be mounted partially or completely internally (e.g., not externally visible) and/or may be covered and/or protected by one or more housing, shrouds, etc. (not shown).

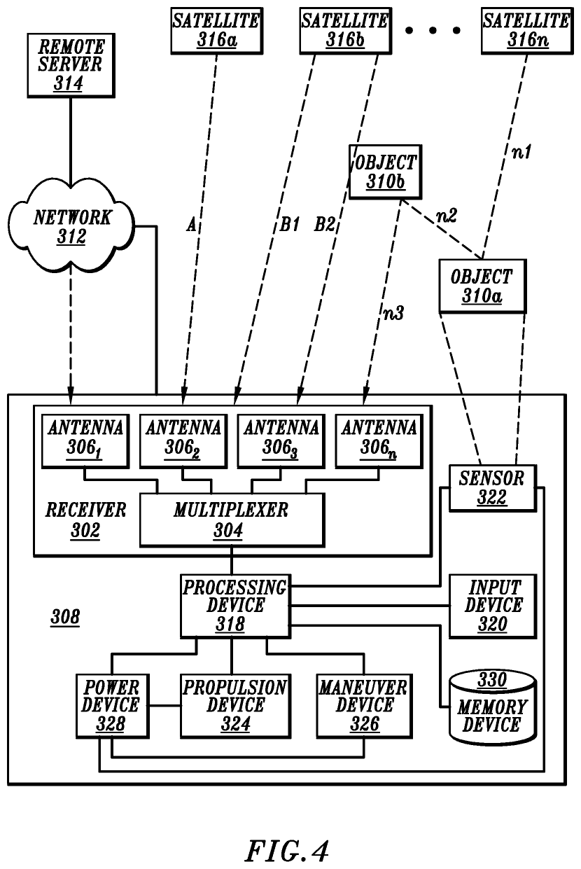

Referring now to FIG. 4, a block diagram of a system 300 according to some illustrative embodiments is shown. In some embodiments, the system 300 includes one or more receivers 302 having a multiplexer 304 and antenna 3061, 3062 . . . 306N coupled to the receiver 302. The antennas 3061, 3062 . . . 306N are mounted to the craft 308 at various locations along the craft 308. In some embodiments, two antenna 306 are mounted to the craft 308. In some embodiments, more than two antenna 306 are mounted to the craft 308. The one or more receivers 302 may be a GNSS or GPS receiver, and, in some embodiments an M-Code receiver. The system 300 further comprises a plurality of objects 310a-b, a network 312, a remote server 314 and a plurality of satellites 316a-n (and/or other navigation signal sources) to ascertain or determine geolocation and/or positioning information of the vehicle 308 based on communications via the network 312 and/or from one or more of the satellites 316a-n (e.g., via respective signals “A1”, “B1”, “B2”, “n1”, “n2”, “n3”). The vehicle 308 may comprise a processing device 318, an input device 320, one or more sensors 322, a propulsion device 324, a maneuver device 326, and/or a power device 328. In some embodiments, the vehicle 308 may be in communication with, e.g., via the network 312, the remote server 314. According to some embodiments, the vehicle 308 may comprise a memory device 330.

According to some embodiments, the objects 310a, 310b may comprise any type, configuration, and/or quantity of objects such as any number or type of obstacles that may block, bend, reflect, refract, distort, and/or otherwise interfere with one or more of the signals “A1”, “B1”, “B2”, “n1”, “n2”, “n3”. As depicted for non-limiting purposes of example in FIG. 4, a primary signal “n1” from an nth satellite 316n may be reflected off of a first object 310a to define a secondary signal “n2” and/or the secondary signal “n2” may be reflected off of a second object 310b to define a tertiary signal “n3”. In such a case, the objects 310a, 310b may comprise buildings, terrain features such as hills or mountains, etc. In some embodiments, a first signal “B1” from a second satellite 316b may be received without obstruction by the vehicle 308 while a second signal “B2” from the second satellite 316b may pass through (and/or otherwise be affected by) the second object 310b. In such a case, the second object 310b may comprise natural and/or man-made diffusive materials such as a tree canopy (branches and/or leaves), electrical wires, smoke, haze, moisture (e.g., mist, rain, etc.), and/or chaff (i.e., man-made and/or man-implemented diffusive, reflective, and/or obstructive materials). According to some embodiments, one or more of the objects 310a, 310b may comprise one or more vehicles (e.g., additional instances of the vehicle 308).

The network 312 may, according to some embodiments, comprise a Local Area Network (LAN; wireless and/or wired), cellular telephone, Bluetooth®, Near Field Communication (NFC), and/or Radio Frequency (RF) network with communication links between the remote server 314 and the vehicle 308. In some embodiments, the network 312 may comprise direct communication links between any or all of the components of the system 300. The sensor 322 may be, for example, directly interfaced or connected to one or more of the processing device 318 and/or the remote server 314 via one or more wires, cables, wireless links, and/or other network components, such network components (e.g., communication links) comprising portions of the network 312. In some embodiments, the network 312 may comprise one or many additional or alternate links or network components other than those depicted in FIG. 4. The vehicle 308 may, for example, be connected to the remote server 314 via various cell towers, routers, repeaters, ports, switches, and/or other network components that comprise the Internet and/or a cellular telephone (and/or Public Switched Telephone Network (PSTN)) network, and which comprise portions of the network 312.

While the network 312 is depicted in FIG. 4 as a single object, the network 312 may comprise any number, type, and/or configuration of networks that is or becomes known or practicable. According to some embodiments, the network 312 may comprise a conglomeration of different sub-networks and/or network components interconnected, directly or indirectly, by the components. The network 312 may comprise one or more cellular telephone networks with communication links between the receiver/communication device 302 and the remote server 314, for example, and/or may comprise an NFC or other short-range wireless communication path, with communication links between the vehicle 308 and one or more of the objects 310a, 310b, for example.

According to some embodiments, the remote server 314 may comprise any type or configuration of a computerized processing device, such as a PC, laptop computer, computer server, database system, and/or other electronic device, devices, or any combination thereof. In some embodiments, the remote server 314 may be owned and/or operated by a third party (i.e., an entity different than any entity owning and/or operating either the vehicle 308 and/or the satellites 316a-n; such as a certificate, authentication, data storage, image analysis, mapping, demographic, graphical element, and/or cryptographic service provider). The remote server 314 may comprise, for example, a server via which cloud-based services, such as AI processing and/or mapping services (e.g., including data descriptive of the objects 310a, 310b) are provided to the vehicle 308. According to some embodiments, the remote server 314 may comprise a plurality of devices (e.g., sensors, transmitters, and/or computing devices) and/or may be associated with a plurality of third-party entities. In some embodiments, the remote server 314 may comprise the memory device 330 (or a portion thereof), such as in the case the remote server 314 comprises a third-party data storage service, device, and/or system, such as the Amazon® Simple Storage Service (Amazon® S3™) available from Amazon.com, Inc. of Seattle, Wash. or an open-source third-party database service, such as MongoDB™ available from MongoDB, Inc. of New York, N.Y.

In some embodiments, the satellites 316a-n may comprise any type and/or quantity of earth-orbiting and/or airborne devices that form a communication network (e.g., the network 312 and/or a separate network comprising the signals “A”, “B1”, “B2”, “n1”, “n2”, “n3”). The communication network may comprise, for example, a geo-location network such as a GNSS/GPS constellation of earth-orbiting satellites 316a-n. According to some embodiments, one or more of the satellites 316a-n may comprise in-atmosphere objects such as drones and/or other aircraft (heavier-than-air or lighter-than-air) that generate any or all of the signals “A”, “B1”, “B2”, “n1”, “n2”, “n3”. In the case that the satellites 316a-n comprise a GPS constellation of satellites, the satellites 316a-n may comprise a subset of twenty-seven (27) total active medium Earth-orbit Space Vehicles (SV) that are (e.g., but—for the objects 302a-b) in line-of-sight with the vehicle 308 at a particular time.

According to some embodiments, the vehicle 308 may comprise any type, configuration, and/or quantity of vehicle, manned, unmanned, autonomous, or semi-autonomous, that is or becomes known or practicable. The vehicle 308 may comprise, for example, an autonomous path-following transportation vehicle that is operable to follow one or more predefined and/or automatically computed paths (not shown) and/or a manned vehicle 308. In some embodiments, the vehicle 308 may comprise the processing device 318 such as a Central Processing Unit (CPU) that executes instructions (not shown) stored in the memory device 330 to operate in accordance with some embodiments described herein. The processing device 318, may, for example, execute one or more programs, modules, and/or routines (such as GNSS/GPS processing routines utilizing some or all of the signals “A”, “B1”, “B2”, “n1”, “n2”, “n3”) that facilitate localization, navigation, and/or movement of the vehicle 308. The processing device 318 may comprise, in some embodiments, one or more Eight-Core Intel® Xeon® 7500 Series electronic processing devices.

According to some embodiments, the receiver 302 is a communication device that includes any wired and/or wireless communication object and/or network device such as, but not limited to, a Network Interface Card (NIC), a Radio Frequency (RF) antenna, transmitter, encoder, decoder, and/or receiver. In some embodiments, the receiver 302 may comprise hardware, software, and/or firmware operable to enable wireless communications including, but not limited to, encoding and/or decoding modules, filters, encryption and/or decryption modules, wireless signal triangulation devices, and/or atomic clock modules. In some embodiments, the receiver 302 may comprise an additional GNSS/GPS antenna and/or receiver that, e.g., in cooperation with the processing device 318, receives and processes some or all of the signals “A”, “B1”, “B2”, “n1”, “n2”, “n3” to determine a geo-location of the vehicle 308.

According to some embodiments, the input device 320 may comprise one or more of a throttle, a steering, and a brake control mechanism and/or interface via which a human operator may control the speed and/or direction of the vehicle 308. According to some embodiments, the input device 320 may comprise one or more switches, levers, wheels, pedals, and/or interface elements capable of communicating speed, direction, etc.

In some illustrative embodiments, the sensor 322 may comprise any type, configuration, and/or quantity of sensor devices that are or become known or practicable. In some embodiments, the sensor 322 may comprise a Light Detection and Ranging (LiDAR), Laser Detection and Ranging (LADAR), radar, sonar, Infrared Radiation (IR), RF, ultrasound, structured light, and/or imaging (e.g., stereo vision and/or 3-D camera) device operable to acquire data descriptive of one or more of the objects 310a, 310b and/or one or more of the satellites 3168a-n. According to some embodiments, the sensor 322 may also or alternatively comprise a gyroscope, image, audio, and/or video capture and/or recording device, chemical detection device, and/or a light sensor. According to some embodiments, the sensor 322 may comprise various movement sensors such as speed/velocity sensors, pressure sensors, temperature sensors, accelerometers, Inertial Measurement Unit (IMU) devices, and/or tilt sensors. In some embodiments, the sensor 322 may comprise one or more sensors operable to detect a bearing, heading, angle, and/or location of one or more of the objects 310a, 310b and/or satellites 316a-n. The sensor 320 may comprise a camera and/or LiDAR device that detects, locates, and/or characterizes (e.g., in coordination with the processing device 318, identifies and/or determines one or more characteristics of; such a shape, size, composition, mass, density, etc.) the second object 310b, for example, and/or may comprise a receiver that is configured to measure a bearing to the nth satellite 316n. According to some embodiments, the sensor 322 (and/or the processing device 318) may utilize both information descriptive of the second object 310b and the nth satellite 316n (and/or the signals “n1”, “n2”, “n3” therefrom) to determine that the second object 310b is likely to be affecting the signals “n1”, “n2”, “n3” from the nth satellite 316n.

According to some embodiments, the propulsion device 324 may comprise any type, configuration, and/or quantity of propulsion devices that are operable to move the vehicle 308 from one location to another. In some embodiments, the maneuver device 326 may comprise any type, quantity, and/or configuration of mechanical, electrical, and/or electro-mechanical devices that are operable to control the path of the vehicle 308 (a/or the direction of thrust output by the propulsion device 324). The maneuver device 326 may comprise, for example, steering linkage, actuators, control surfaces, thrust vectoring devices, etc. In some embodiments, the maneuver device 326 may be coupled to and/or in communication with the propulsion device 324. The maneuver device 326 may comprise, for example, a steer-by-wire system that permits computerized control (e.g., via the processing device 318 and/or the remote server 314) of the maneuvering of the vehicle 308. The maneuver device 326 and the propulsion device 324 may, for example, operate in a coordinated fashion (e.g., in response to commands from the processing device 318) to cause the vehicle 308 to follow a desired path and/or route.

According to some embodiments, the power device 328 may be electrically coupled to provide power to any or all of the components. In some embodiments, the power device 328 may comprise a power source such as a solar panel, inertial generator, on-board generator, alternator, fuel-cell, external power supply port, etc. According to some embodiments, the power device 328 may also or alternatively comprise a power storage device such as one or more capacitors, batteries, fuel reservoirs or tanks, etc.

In some embodiments, the memory device 330 may store various logic, code, and/or applications, each of which may, when executed, participate in, facilitate, and/or cause selective and/or opportunistic GNSS/GPS navigation processing, as described herein. In some embodiments, the memory device 330 may comprise any type, configuration, and/or quantity of data storage devices that are or become known or practicable. The memory device 330 may, for example, comprise an array of optical and/or solid-state memory cards or hard drives configured to store sensor data, geo-location data, maneuvering data, object location and/or classification data, navigation data, road network data, rules of the road data, routing data (e.g., analysis formulas and/or mathematical models), credentialing and/or communication instructions, codes, and/or keys, and/or various operating instructions, drivers, etc. In some embodiments, the memory device 330 may comprise a solid-state and/or non-volatile memory card (e.g., a Secure Digital (SD) card, such as an SD Standard-Capacity (SDSC), an SD High-Capacity (SDHC), and/or an SD eXtended-Capacity (SDXC) and any various practicable form-factors, such as original, mini, and micro sizes, such as are available from Western Digital Corporation of San Jose, Calif. While the memory device 330 is depicted as a stand-alone component of the vehicle 308, the memory device 330 may comprise multiple components. In some embodiments, a multi-component memory device 330 may be distributed across various devices and/or may comprise remotely dispersed components. Any of the vehicle 308, the satellites 316a-n, the objects 310a-b, and/or the remote server 314 may comprise the memory device 330 or a portion thereof, for example.

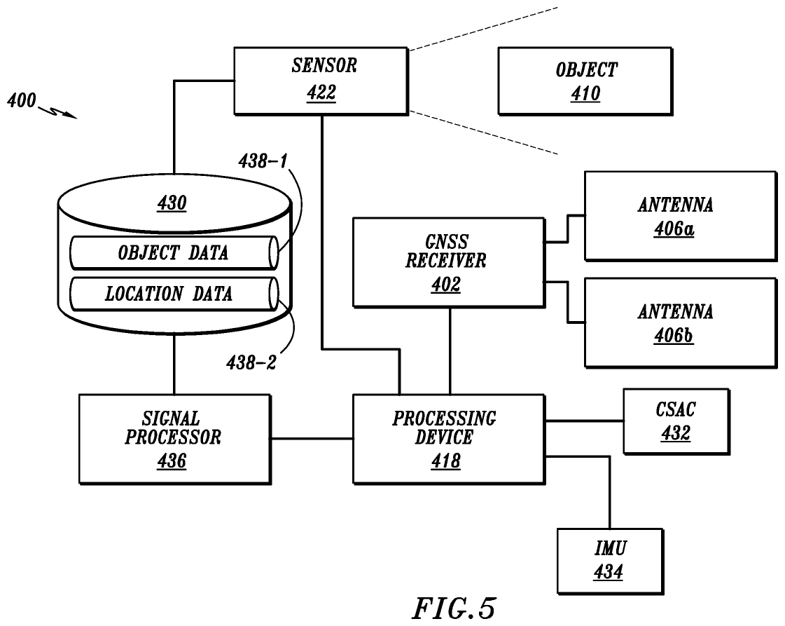

Referring now to FIG. 5, a block diagram depicting an exemplative illustrative embodiment of the system of the present invention is illustrated. The system 400 includes an object 410 (e.g., an obstruction and/or interference), one or more processing devices 418, one or more GNSS receivers 402 (including the receiver and multiplexer architecture of FIG. 2), one or more antennas 406a, 406b, a Chip Scale Atomic Clock (CSAC) 432, an IMU 434, a sensor 422, a signal processor 436, and/or a memory device 430 (e.g., storing object data 438-1 and/or location data 438-2). The memory device 430 may comprise a database containing a description of open areas where the sky can be seen directly without occlusions (e.g., the object data 444-1), for example, and/or the processing device 418 may comprise a controller/computer programmed to process localization solutions for pseudoranges coming from satellites (not shown).

One or more signals from one or more satellites may be received by the antennas 406a, 406b and the incoming data/input may be provided to and/or processed by the GNSS receiver 402. In some embodiments, the processing device 418 may execute stored instructions in coordination with data from the GNSS receiver 402. The signal processor 436 may be a component of the processing device 418 and may perform one or more processing functions on the signals on the signals including, without limitations, filtering, noise suppressing, attenuating, converting, transforming etc.

The system 400 may comprise a CSAC 432, which may include, for example, an accurate clock that can process the GNSS solution over time by sequentially receiving different satellite signals via the antennas 406a, 406b. The system 400 may also include an IMU 434 that may, for example, provide inertial/visual odometry/LiDAR odometry and/or other relative localization data to measure a change in pose within subsequent GNSS measurements.

With continued reference to FIG. 5, the system 400 may include one or more sensors 422 that builds and/or populates the object data 438-1 and/or the location data 438-2 by detecting, identifying, locating, and/or classifying the object 410. In such a manner, for example, the configuration of the system 400 may self-build and/or derive a model and/or mapping of clear and obstructed sky areas, bearings, locations, etc., without the need to utilize data from a separate and/or remote source. According to some embodiments, the sensor 422 may sense and/or detect various environmental and/or object data such as data descriptive of a size, shape, location, density, and/or temperature of the object 410, and/or wind, rain, light, humidity, magnetic field, and/or pressure measurements. Wind measurements from the sensor 422 may be, for example, utilized to predict and/or track smoke and/or other transient and/or mobile interferences. This data may be stored as location data 438-2. The system 400 further includes multiple antennas, for example, two or more antennas 406a, 406b utilized to receive signals from multiple satellites (e.g., in different clear sky areas) at a single time.

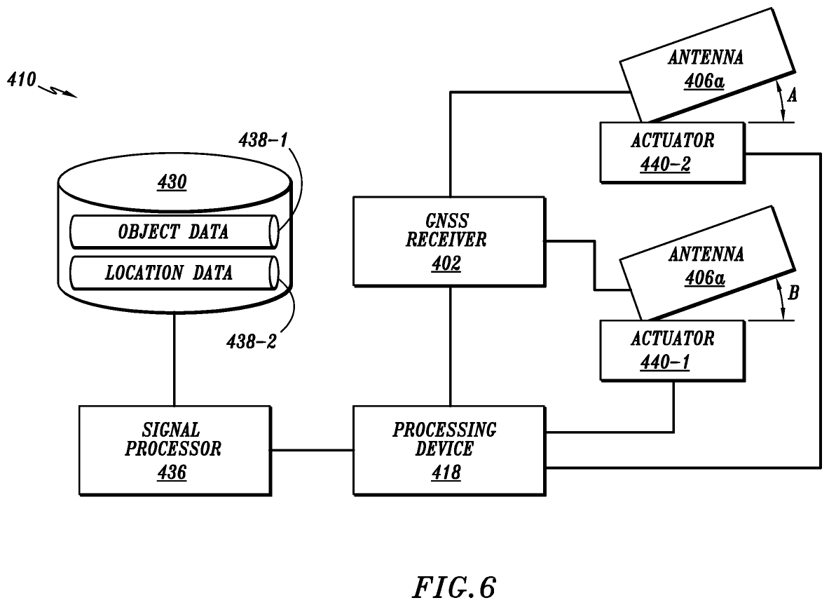

FIG. 6 illustrates a system 410 including one or more actuators 440-1, 440-1 coupled to antennas 406a, 406b. The processing device 418 may query the memory device 430 and retrieve satellite location/bearing data, for example, and in coordination with the processing device 418 may command the respective actuators 440-1, 440-2 to selectively position the directional antenna 406a at an angle “A” and/or the directional antenna 406b at an angle “B” (e.g., with respect to the horizon as shown and/or with respect to one or more other planes of reference) and positions therebetween. In the case that the directional antenna 406a, 406b defines a particular range, aperture, and/or sensing area with respect to a direction in which the directional antenna 406a, 406b is selectively oriented, the direction may be selected to ensure that the range, aperture, and/or sensing area stays oriented with one or more “open sky” areas, e.g., to prevent reception of reflected, refracted, bent, and/or otherwise degraded and/or suspect signals.

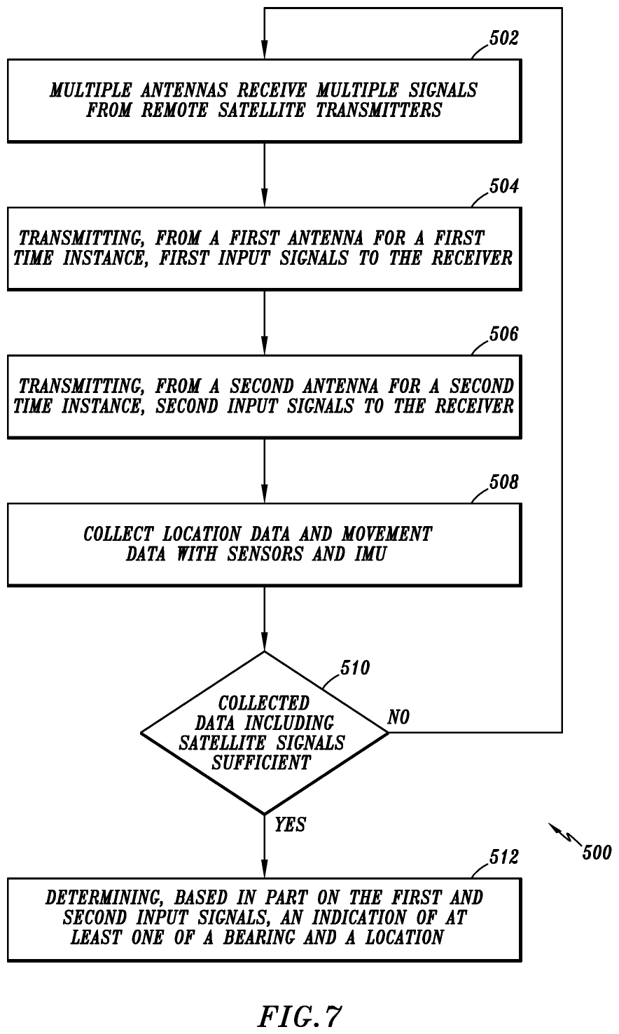

Referring now to FIG. 7, a flow diagram of a methodology 500 associated with the use of one or more systems according to one or more illustrative embodiments is shown. In some embodiments, the method 500 may be performed and/or implemented by and/or otherwise associated with one or more specialized and/or specially-programmed computers described hereinabove. In some embodiments, the method 500 includes receiving, by at least two antennas coupled to a receiver, a plurality of signals from a plurality of different remote satellite transmitters (STEP 502). The method continues by, transmitting, from a first antenna and for a first time instance T₁, first input signals to the receiver 202, 302, 402. In illustrative embodiments, either antenna 206a, 306a, 406a; 206b, 306b, 406b may be initially identified to transmit a first group of signals. As described hereinabove, each antenna 206a, 306a, 406a; 206b, 306b, 406b is coupled or associated with a receiver 202, 302, 402, which in some embodiments, is a single receiver. In some embodiments, multiple receivers are provided. The multiplexer 204, 304 channels the signals from either of the antennas 206a, 306a, 406a; 206b, 306b, 406b as a single output O to the receiver 202, 302, 402. (FIG. 2). In some embodiments, the particular antenna 206a, 306a, 406a; 206b, 306b, 406b initially selected is based on code or logic embodied in the memory of the processing device. In some embodiments, the code or logic includes instructions for initially activating the first selected antenna 206a, 306a, 406a for a predetermined time period. In some embodiments, the particular antenna selected in STEP 504 is based on other parameters including, without limitation, lack of a signal, number of signals received from a number of satellites, strength and/or quality of the signals received by the respective antennas, signal interference, noise, environmental factors, detection of the object 210, 310, 410 or any other criteria detected or processed by the one or more sensors 322, 422, IMU 434, etc. of the system. In illustrative embodiments, the first time instance T₁ for transmitting the first group of signals may be predetermined, e.g., set for a predetermined time. In some embodiments, the first time instance T₁ may extend or terminate based on any of the aforementioned parameters including, without limitation, signal strength, signal loss, and/or environmental conditions detected by one or more sensors 322, 422.

Once the first time instance T₁ is over, the method continues via the multiplexer 204, 304 switching to the second antenna 206b, 306b, 406b to enable transmission, for a second time instance T₂, the second input signals to the receiver. (STEP 506) As noted hereinabove, transition to the second antenna 206b, 306b, 406b is controlled by the multiplexer 204, 304, which, in illustrative embodiments, is in response to achieving an initial predetermined time period of use of the first antenna 206. In some embodiments, the multiplexer 204, 304 may switch to the second antenna 206b, 306b, 406b to transmit the second group of signals in response to detection and/or monitoring multiple parameters including signal strength, noise, distortion associated with the first set of signals received by the first antenna or based on other environmental parameters. For example, in response to a weak signal, distorted signal or lack of a signal associated with the first group of signals received by the first antenna 206a, 306a, 406a, the logic associated with the processor and/or receiver 202, 302, 402 may activate the multiplexer 204, 304 to cause a switch to the second antenna 206b, 306b, 406b whereby signals associated with the second group of signals are directed to the receiver as output O from the multiplexer 204, 304. The second antenna 206b, 306b, 406b transmits the second signals to the receiver 202, 302, 402 for a second time instance T₂. The second time instance T₂ may be predetermined or may be responsive to any of the aforementioned detection or monitoring of parameters described hereinabove. For example, in response to the detection of a weak or distorted signal associated with the second satellite signals received by the second antenna 206b, 306b, 406b, the logic associated with the receiver 202, 302, 402 or the processing device 318, 418 may send a signal to the multiplexer 204, 304 to switch back to the first antenna 206a, 306a, 406a.

In STEP 508, location data and movement data of the craft is collected by the sensors such as speed/velocity sensors, pressure sensors, temperature sensors, accelerometers, Inertial Measurement Unit (IMU) devices, and/or tilt sensors, clock, environmental conditions, etc. In illustrative embodiments, the data in STEP 508 is collected continuously or contemporaneously with performance of the other STEPS 502-506. If it is determined that the data collected via the satellite antenna 206a, 306a, 406a; 206b, 306b, 406b and processed by the receiver 202, 302 along with in, in some embodiments, the data collected in STEP 508, is sufficient (YES) (STEP 510), a determination is made regarding at least one of the location or bearing of the craft 100. (STEP 512). If the information is insufficient and if more satellite signal data is needed (NO), the process repeats itself by returning to STEP 502 and repeating the STEPS 502-508 at least once, and, in illustrative embodiments, multiple times or sequences. For example, and without limitation, the steps may include selectively transmitting from the first antenna 206a, 306a, 406a and for a third time instance subsequent to the second time instance, third input signals to the receiver 202, 302 followed by selectively transmitting from the second antenna 206b, 306b, 406b and for a fourth time instance subsequent to the third time instance, fourth input signals to the receiver 202, 302 for processing. Additional sequences are also contemplated.

In illustrative embodiments, STEP 508 may be optional and at least the location and/or bearing of the craft may be solely determined by the satellite signals collected by the antenna 206a, 306a, 406a; 206b, 306b, 406b and processed by the receiver 202, 302. For example, it is envisioned that the signals from at least four (4) satellites may be collected by the antennas 206a, 306a, 406a; 206b, 306b, 406b, in illustrative embodiments, at about the same point in time due to the switching frequency associated with the multiplexer 204, 304. The pseudoranges for each of the satellites may be determined to thereby enable calculation of the location and/or bearing of the craft 200, 308 through known trilateration techniques based solely on the signals received by the antennas 206a, 306a, 406a; 206b, 306b, 406b. In some embodiments, it is envisioned that the first antenna 206a, 306a, 406a may receive signals from multiple satellites and the second antenna 206b, 306b, 406b may receive signals from different multiple satellites. In such embodiments, the sequential changing of the input by the multiplexer 204, 304 from each of the respective antennas 206a, 306a, 406a; 206b, 306b, 406b permits the processing of at least four signal groups from four different satellites with appropriate respective time stamps and collected positional data to enable calculation via trilateration techniques.

In some embodiments, the data collected by the satellite antennas antenna 206a, 306a, 406a; 206b, 306b, 406b is combined with the data collected by the various sensors and components of the IMU to formulate at least one of the location, bearing and/or heading of the craft even while the craft is traversing a terrain. For example, the sequential architecture may use the CSAC clock and an inertial system to sequentially acquire positioning by reading pseudoranges from the different satellites at different times and computing the solution by utilizing the inertial solution and accurate clock to create the system of equations necessary to solve for position and time.

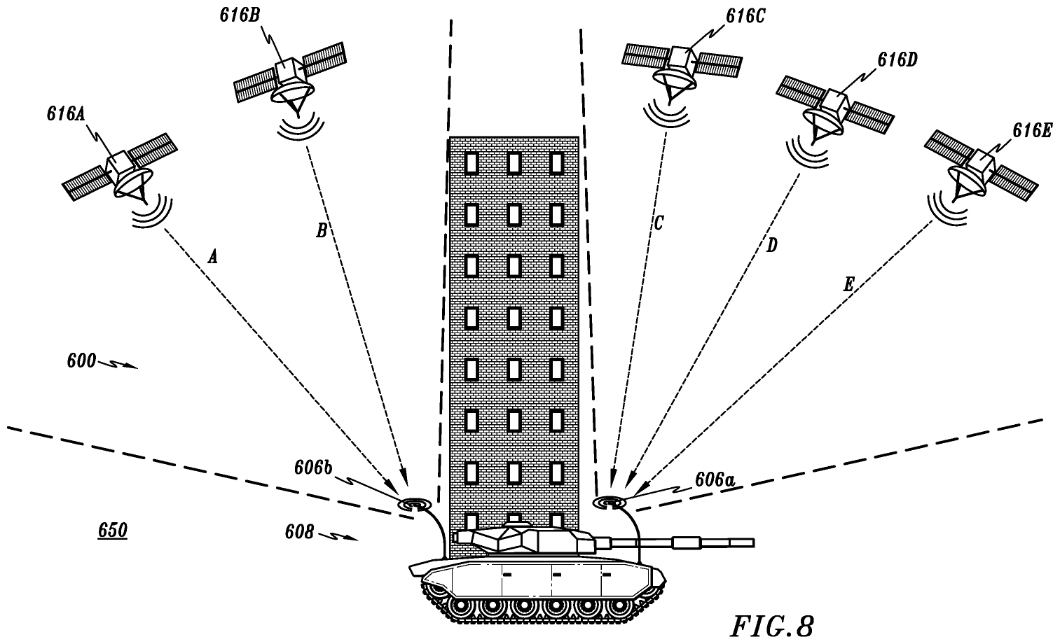

FIG. 8 is a diagram according to some embodiments. The system 600 may comprise, for example, the craft 608 and one or more objects 610 (only one shown for clarity) disposed around a craft 608 in an environment 650 along which the craft 608 traverses. The craft 608 includes multiple antennas, for example, two antennas 606a, 606b, mounted to the fore and aft areas of the craft 608. As noted, the antennae 606a, 606b may be positioned anywhere on the craft including, without limitation, the lateral sides of the craft 608. (FIG. 3). In general, in an open sky environment and in the absence of an object, each antenna 606a, 606b provides a cone, sphere or geometric plane of vision for reception of the signals from the satellites 616A, 616B, 616C, 616D, 616E. However, in the presence of one or more objects, certain signals may be blocked by reception of respective antennas 606a, 606b For example, in the location of the craft 608 depicted in FIG. 8, the one or more objects 610 impede transmission of signals A, B from satellites 616A, 616B to the forward antenna 606a and impede transmission of signals C, D, E from satellites 616C, 616D, 616E to the aft antenna 606b. According to some embodiments, the system 600 may determine one of the bearing and geo-location of the craft 608 by selectively processing the signals received by the respective antennas 606a, 606b based on strength and/or number of signals received by the respective antennas 606a, 606b.

With reference again to the flow chart of FIG. 7 in conjunction with FIG. 8, as the craft 608 traverses the environment 650, multiple signals from multiple satellites 616A, 616B, 616C, 616D, 616E are received by the respective antenna 606a, 606b. (STEP 502). Upon encountering an object 610, certain signals may be outside the direct line of sight of the antenna 606a, 606b or at the very least, the object 610 may impede reception of certain signals by the respective antennas 606a, 606b. Thus, a determination is made as to which antenna 606a, 606b is selected for transmission to the receiver for processing of the respective signals. This determination, in some embodiments, may correspond to the number of satellite signals (satellite fix rule) received by the antenna 606a, 606b. For example, and without limitation, in FIG. 8 in the presence of the object 610, the forward antenna 606a is fixed on three satellites 616C, 616D, 616E while the aft antenna 606b is fixed on two satellites 616A, 616B. In some embodiments, the system will then transmit and process the signals from the forward antenna 606a based on the greater number of satellite fixes of the forward antenna 606a relative to the aft antenna 606b. The transmission and processing may occur for a first time instance, corresponding to STEP 504 of the flow chart of FIG. 7. As the craft 608 traverses the environment 650 and moves relative to the object 610, the aft antenna 606b may fix on three satellites, for example, satellites 616A, 616B, 616C. A determination is made for the multiplexer to switch to the aft antenna 606b to process the signals received by the aft antenna 606b for a second period of time, corresponding to STEP 506 of the flow chart 500. In some embodiments, the collected data by the satellite antennas 606a, 606b may be combined with the data collected by the various sensors and components of the IMU to formulate at least one of the location, bearing and/or heading of the craft even while the craft 608 is traversing a terrain, corresponding to STEP 512 of the flow chart 500.

In some embodiments, the switching sequence of the multiplexer 204, 304 is initiated based on a threshold number of signals/satellites coupled to the antennas. For example, if a threshold number of satellites are coupled to a given antenna within for example, a given time period, the multiplexer switches to the given antenna. If less than the threshold number is achieved within the given time period, the multiplexer switches to the other antenna.

The multiantenna/multiplexer/receiver arrangement of the present invention provides significant improvements over existing GPS or GNNS systems. The ability to couple multiple antennas to a single receiver is extremely cost effective particularly in use with M-code military receivers which are quite expensive. The multiple antennas may be dispersed about the craft and need not be mounted to the roof or hood of the craft. This proves advantageous particularly in light of the space constraints associated with, for example, military vehicles. The antennas may be spaced from each other on the craft such that at least one antenna may have a clear line of sight with a given satellite(s) while the remaining others do not. More specifically, the antennas may have different views of the sky. The sequential or alternating selection of the antennas through the logic associated with the multiplexer may provide continuous collection of signals from multiple satellites even if one of the antennas is devoid of a clear line of site with a given satellite. This enables calculation of the location and/or bearing of the craft through multiple antennas with a single receiver.

In some embodiments, the switching sequence of the multiplexer between antennas is predefined, and may be set for an initial predetermined period of time for each antenna. In some embodiments, the switching sequence is repeated one or more times for set time periods which may be the same or different from the initial predetermined time periods. In some embodiments, the quality and/or strength of the signals is monitored and logic associated with the multiplexer initiates the switching sequence of the multiplexer. In accordance with some embodiments, the time is not predetermined but is dependent on the signal quality. When signal quality deteriorates beyond a threshold in one antenna, the multiplexer switches to the other antenna(s). In some embodiments, if signal quality improves in one antenna beyond a threshold, the multiplexer automatically switches to that specific antenna. In some embodiments, environmental conditions are monitored whereby the logic associated with the multiplexer initiates the switching sequence between antennas of the multiplexer based on environmental conditions. In some embodiments, the relative number of signals received by the antennas, corresponding to a number of satellites to which the antenna is “fixed,” determines at least in part the switching sequence.

In some embodiments, a second receiver, for example, a commercial receiver is incorporated in the system. The first receiver 202, 302 may be an M-Code receiver with the multiplexer logic anti-jamming capabilities. The second receiver may provide additional data for determining location and heading of the craft, alone, or in combination with the data collected by the sensors. In addition, the second receiver may be coupled to the processor, and used to detect spoofing attacks against the navigation satellite system. For example, a difference (or delta) in signal characteristics collected by the first M-Code receiver and the second commercial receiver may be indicative of spoofing activities being carried out by third parties.

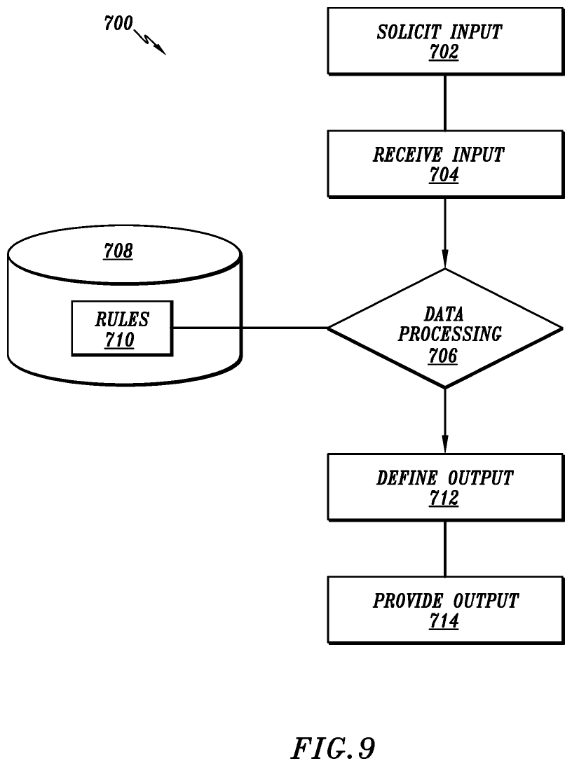

With reference to FIG. 9, for example, any of the computing or processing devices described hereinabove may include storage or memory for storing or loading one or more algorithms to control at least operation of the receiver, multiplexer and the antenna architecture. The algorithm 700 may comprise, for example, one or more software programs, modules, engines, and/or applications coded to perform any of the method of FIG. 7 herein, and/or portions thereof. The algorithm 700, and any reference to the term “algorithm” herein, refers to any set of defined instructions that operate upon input to define and/or provide output 714. The algorithm 700 may, for example, be specifically programmed and/or otherwise defined to instruct a computer or other device (not shown) to solve a particular problem (e.g., logical) and/or resolve a particular mathematical calculation (e.g., arithmetic). In some embodiments, the algorithm 700 may be written and/or defined as a series or sequence of instructions encoded in (e.g., written in accordance with syntax and/or semantics rules) a particular computer programming language (e.g., Python™, Java™, JavaScript™, C, C++, C#, Basic™, FORTRAN, COBOL, Ruby™, and/or Perl™), e.g., a set of instructions that convert and/or encode characters, objects, and/or other data elements into machine code (e.g., code operable to be executed by an electronic processing device, such as a CPU).

According to some embodiments, the algorithm 700 may comprise soliciting input, at 702. Input from one or more sources may be searched for and/or queried, by structuring and/or executing a database query and/or by sending a data communication signal or “handshake”, such as is common with Bluetooth® short-range communication protocols. In some embodiments, the algorithm 700 may comprise receiving the input, at 704. Whether solicited or otherwise provided and/or acquired (e.g., received as an incoming signal, loaded and/or downloaded), for example, the input for the algorithm 700 may be received, identified, and/or otherwise processed and/or located. According to some embodiments, the algorithm 700 may comprise data processing, at 706. The data processing 706 may, for example, comprise execution of one or more logical and/or computational procedures, modules, scripts, and/or routines that may be stored in a memory device 708 as a set of instructions or rules 710 and/or that may be defined and/or implemented by one or more electrical, mechanical, and/or physical components, such as logic gates, diodes, transistors, relays, and/or switches (e.g., operable to execute the method of FIG. 7 herein, and/or portions thereof).

In some embodiments, execution of the algorithm 700 may comprise a loading of the rules 710 into the memory 708 and/or into an electronic processing system (not shown) and/or an activation of one or more logic gates and/or other electrical and/or mechanical components. The algorithm 700 may operate upon the input in accordance with the rules 710 to achieve a result by defining output, at 712. The algorithm 700 may, for example, generate, produce, define, identify, calculate, and/or otherwise compute output based on an application of the data processing 706 utilizing the rules 710 and any or all input receiving at 704. According to some embodiments, the algorithm 700 may comprise providing the output, at 712. One or more output devices (not shown) may be utilized to convey the output (e.g., a result, conclusion, decision, etc.) to one or more other devices and/or entities (not shown), such as one or more users, consumers, customers, potential customers, and/or devices utilized thereby. The output may be displayed via an electronic display screen of a computer, mobile/smart phone, smart watch, etc., and/or may be transmitted as one or more electronic signals to one or more network destination addresses, such as e-mail addresses, URL locations, MAC addresses, and/or broadcast radio frequencies.

According to some embodiments, the data processing at 706 may comprise execution of a listing, sequence, matrix, and/or other set of stored steps and/or instructions that utilize the input to define the output. In some embodiments, the listing of steps and/or instruction details may comprise elements that are known to those skilled in the art. The algorithm 700 may partially or completely comprise, for example, instructions and/or steps that are well known, such as steps and/or instructions operable to calculate an area (length times width), volume (length times width times height), distance (difference between two locations), velocity (distance over time), acceleration (velocity over time), GNSS/GPS location, and/or any other known mathematical and/or logical (if/then statements) procedures. For any and all known procedures and/or instructions, the discrete details of such instructions are represented by the data processing at 706 and are not listed herein as one of ordinary skill in the art would readily comprehend both what such technological knowledge entails and that the inventor has possession of such knowledge. Instructions that may be included within and/or comprise the data processing at 706 (and/or the algorithm 700) may include, for example, but are not limited to, any known or practicable: (i) GNSS, GPS, and/or other navigational geo-location resolution algorithms, (ii) Al and/or ML data input classification algorithms, (iii) data transmission algorithms, (iv) data encoding algorithms, (v) data decoding algorithms, (vi) logical and/or mathematical data comparison algorithms, and (vii) data searching (e.g., keyword searching) algorithms.

### Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms and/or programs that are written to achieve a particular output and/or output goal—e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. (e.g., “non-transitory”). Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. A navigation system, comprising:
at least one processor;
a receiver in communication with the at least one processor; and
a non-transitory computer-readable medium storing instructions that when executed by the at least one processor results in:
receiving, by at least two antennas coupled to a receiver, a plurality of signals from a plurality of different remote transmitters;
transmitting, from a first antenna and for a first time instance, a first input signal to the receiver, the first input signal associated with a first group of the plurality of signals;
transmitting, from a second antenna and for a second time instance subsequent to the first time instance, a second input signal to the receiver, the second input signal associated with a second group of the plurality of signals; and
determining, based at least in part on the first and second input signals, an indication associated with at least one of a bearing and a location of a craft.

2. The navigation system according to claim 1 wherein the instructions, when executed by the at least one processor, further causes multiplexer logic to selectively deliver an individual one of the first and second input signals to the receiver.

3. The navigation system according to claim 2 wherein the instructions, when executed by the at least one processor, causes the multiplexer logic to selectively deliver the individual one of the first and second input signals based at least in part on time criteria.

4. The navigation system according to claim 2 wherein the instructions, when executed by the at least one processor, causes the multiplexer logic to selectively deliver the individual one of the first and second input signals based at least in part on one or more parameters associated with the first and second groups of the plurality of signals.

5. The navigation system according to claim 4 wherein the one or more parameters includes at least one of signal strength, signal quality and noise.

6. The navigation system according to claim 4 wherein the one or more parameters includes a number of signals received by the first antenna and the second antenna.

7. The navigation system according to claim 2 wherein the instructions, when executed by the at least one processor, further causes the multiplexer logic to:
selectively transmit from the first antenna and for a third time instance subsequent to the second time instance, a third input signal to the receiver, the third input signal associated with a third group of the plurality of signals; and
selectively transmit from second antenna and for a fourth time instance subsequent to the third time instance, a fourth input signal to the receiver, the fourth input signal associated with a fourth group of the plurality of signals.

8. The navigation system according to claim 1 wherein the first and second antennas are mounted to the craft.

9. The navigation system according to claim 1 wherein at least one of the first and second antennas is a directional antenna.

10. The navigation system according to claim 9 further comprising:
an actuator that is operable to receive a command from the at least one processor and in response to the command, reorient the directional antenna from an initial bearing to a second bearing.

11. The navigation system according to claim 1 wherein the instructions, when executed by the at least one processor, further causes one or more sensors associated with the craft to collect positional data; and
wherein determining the indication includes utilizing the positional data to determine the at least one of a bearing and a location of a craft.

12. A method for determining at least one of a location and bearing of a craft, comprising:
mounting first and second antennas and a receiver, coupled to the first and second antennas, to a craft;
receiving, by the first and second antennas, a plurality of signals from a plurality of different remote transmitters;
sequentially transmitting, to the receiver, input signals from the first antenna and from the second antenna; and
determining based at least in part on the input at least one of a bearing and a location of the craft;
wherein the steps are performed by at least one processor coupled to memory.

13. The method according to claim 12 wherein sequentially transmitting includes:
transmitting, from the first antenna and for a first time instance, a first input signal to the receiver, the first input signal associated with a first group of the plurality of signals; and
transmitting, from the second antenna and for a second time instance subsequent to the first time instance, a second input signal to the receiver, the second input signal associated with a second group of the plurality of signals.

14. The method according to claim 13 wherein sequentially transmitting is performed with a multiplexer coupled to the receiver.

15. The method according to claim 14 wherein sequentially transmitting includes switching, via the multiplexer, transmission of the first input signal from the first antenna to the second input signal of the second transmitter after a predetermined time period.

16. The method according to claim 14 wherein sequentially transmitting includes switching, via the multiplexer, transmission of the first input signal from the first antenna to the second input signal of the second transmitter based at least in part on one or more parameters associated with the plurality of signals.

17. The method according to claim 16 wherein the one or more parameters includes at least one of signal strength, signal quality and noise.

18. The method according to claim 16 wherein the one or more parameters includes a number of signals received by the first antenna and the second antenna.

19. The method according to claim 12 including collecting positional data with one or more sensors associated the craft; and
wherein determining an indication includes utilizing the positional data to determine the at least one of a bearing and a location of the craft.
